(19) United States
(12) Patent Application Publication
(10) Pub. No.: US 2013/0095787 A1
(43) Pub. Date: Apr. 18, 2013

(54) DATA TRANSPORT BUNDLE

(71) Applicant: Cellco Partnership d/b/a Verizon Wireless, Basking Ridge, NJ (US)

(72) Inventor: Nematolah KASHANIAN, Hackensack, NJ (US)

(73) Assignee: CELLCO PARTNERSHIP D/B/A VERIZON WIRELESS, Basking Ridge, NJ (US)

(21) Appl. No.: 13/706,203

(22) Filed: Dec. 5, 2012

Related U.S. Application Data
(63) Continuation-in-part of application No. 13/166,237, filed on Jun. 22, 2011.
(60) Provisional application No. 61/567,009, filed on Dec. 5, 2011.

(51) Int. Cl. H04W 4/26

(52) U.S. Cl. CPC H04W 4/26
USPC 455/406

(57) ABSTRACT

A data transport bundle is presented that is a package of wireless data transport created by a mobile communication network provider. The data transport bundle is available for sale by the mobile communication network provider to enterprises that wish to use wireless data transport. The data transport bundle may include the duration, number of allowed transactions, size associated with each allowed transaction and a price associated with the data transport bundle. The mobile communication network provider may configure the data transport bundle so that it may be partitioned into multiple smaller data transport bundles. In addition, the components of the data transport bundle, such as the duration, number of allowed transactions, and size associated with each allowed transaction may be adjustable to satisfy services for which the enterprise purchases the data transport.

### RELATED APPLICATIONS

This application claims priority from U.S. Provisional Application No. 61/567,009, filed on Dec. 5, 2011, and is a continuation in part of U.S. application Ser. No. 13/166,237, filed on Jun. 22, 2011, and entitled “Open Data Transport Bundle Marketplace Exchange.” The contents of the provisional application and the continuation-in-part application are incorporated herein in their entirety.

### BACKGROUND

In recent years, consumer consumption of mobile data has rapidly increased with increased availability and popularity of mobile devices. Advanced mobile devices, such as mobile phones, provide a subscriber of a mobile service provider (e.g., Verizon Wireless™) with means to communicate with others using voice, SMS, electronic mail services, and a variety of multimedia and Internet data services. Mobile devices with Internet data service for example allow subscribers the ability to browse web pages, set-up wireless internet end points, use web applications, make purchases, and share information. Consequently, an increase in data consumption has increased the costs to network service providers due to high licensing fees and the need to build faster networks. Network service providers in turn have phased out unlimited data plans and replaced them with tiered data plans.

This increased access to the Internet and web-based applications has also increased interest from enterprises to create Internet enabled applications and browser based web applications for customers to use via mobile devices. For example, recognizing that more and more users read newspapers on electronic devices, a newspaper publisher would like to partner with an electronic book reader (e-book reader) manufacturer to sponsor access to the Internet from e-book readers for downloading of the electronic version of the newspaper. Many users, however, pay for these services based on the amount of their data consumption. The newspaper publisher also recognizes that in the interest of minimizing mobile data consumption due to costs, users have become more selective as to which sites they visit from their e-book readers. Therefore, the newspaper publisher may want to sponsor data access to their website from the e-book readers for downloading the newspaper. Sponsorship would allow users to access the web site over a network without incurring the user's own data usage charges with the network provider. However, because mobile service providers either do not provide data transport bundles for sale or only make data bundles available using a wholesale model for large quantities of data transport for a large cost and taking months to finalize, it is prohibitively expensive for the enterprise to purchase such data bundles. Consequently the enterprise is unable to offer data usage to its website users. In addition, due to the limited flexibility and customization of existing corporate wholesale data plans for users and the long time it takes for enterprises to purchase a large data contract with a network provider, an enterprise may not be able to offer such a sponsorship.

Hence a need exists for creating alternative data plans for mobile network subscribers utilizing data transport from data bundles.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates exemplary processes for using a mobile data transport market exchange to develop an offer for a service to mobile device end users.

FIG. 2 illustrates a mobile communication network as may be operated by a carrier or service provider.

FIG. 3 illustrates exemplary processes for creating a Data Transport Bundle.

FIG. 4 illustrates exemplary processes for creating an Alternative Data Plan.

FIG. 5 illustrates exemplary processes for purchasing an Alternative Data Plan

FIG. 6 illustrates exemplary processes for searching for an Alternative Data Plan

FIG. 7 is a simplified functional block diagram of a computer that may be configured as a host server, for example, to function as an ODME website host server.

FIG. 8 is a simplified functional diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

An aspect of this disclosure is a server comprising at least one processor, a non-transitory storage medium and one or more files stored in the non-transitory storage medium for processing by the at least one processor. The one or more files defining a data transport bundle (DTB). The DTB is a package of wireless data transport for sale to an enterprise by a mobile communication network provider for services that use wireless data transport. The one or more files have a data structure containing parameters of the DTB comprising: duration defining a time period during which the data transport bundle is valid, a number of allowed transactions defining a number of transactions that are allowed for the data transport bundle, a megabyte (MB) size associated with each of the allowed transactions and a price associated with the data transport bundle. In the past, data was only available for purchase by an enterprise from a wireless network provider if the amount of data to be purchased exceeded a minimum amount. In the present disclosure, the data transport bundle may be available to the enterprise irrespective of the amount of data the enterprise has purchased in the past or would like to purchase in the future. The duration, the number of allowed transactions, and the size of data transport bundle may be adjustable to satisfy services for which the enterprise purchases the data transport, and the data transport bundle may be configured to be partitioned into multiple smaller data transport bundles. The data structure of the one or more files allows the DTB to be available to an enterprise irrespective of amount of data the enterprise has purchased from the mobile communication network provider in the past or would like to purchase in the future. The files allow the DTB to be partitioned into a plurality of DTBs.

The files allow the DTB to be configured to be combined with another data transport bundle, shared by the enterprise with another enterprise such that profits generated by the DTB are shared, sold by the enterprise to another enterprise, or associated with an alternative data plan (ADP). The price associated with the data transport bundle (e.g., overage charges, international roaming charges, and the quality of service (QoS)) may be varied. The QoS may be configured according to the type of applications being used and/or according to the network technology allowed.

Another aspect of this disclosure is a method in which an offer and acceptance are exchanged to create an agreement between a mobile communication network provider and an enterprise for the mobile communication network provider to provide a data transport bundle as a package of wireless data transport to the enterprise through the mobile communication network for creation of services of the enterprise that require wireless data transport. The data transport bundle may contain features similar to those above. The method also includes providing data transport through the mobile communication network for customers of the enterprise consuming the data transport bundle. In addition, the method includes, responsive to operation of the mobile communication network, accumulating and processing data regarding the consumption of the data transport bundle via a computer, to account for the transport consuming resources of the data transport bundle in accordance with the data transport bundle agreement.

Yet another aspect of this disclosure is a system that includes a system comprising a mobile communication network of a network service provider configured to provide transport for mobile data communication services. The system may also include a billing system computer coupled to one or more elements of the mobile communication network configured to accumulate and process data regarding usage of the transport for mobile data communication services through the mobile communication network. In addition, the system may include a data transport bundle as indicated above. The DTB is provided as a package of wireless data transport to an enterprise for creation of services of the enterprise that employ wireless data transport through the mobile communication network. The billing system computer is further configured to accumulate and process data regarding consumption of the data transport bundle, to account for the transport consuming resources of the data transport bundle in accordance with the data transport bundle agreement.

Another aspect of this disclosure is one or more files stored in a non-transitory storage medium for processing by the at least one processor. The one or more files define a data transport bundle (DTB), which is a DTB is a package of wireless data transport for sale to an enterprise by a mobile communication network provider for services that use wireless data transport. The one or more files may have a data structure containing parameters of the DTB comprising: a duration defining a time period during which the data transport bundle is valid; a number of allowed transactions for the data transport bundle; a megabyte (MB) size associated with each of the allowed transactions; and a price associated with the data transport bundle.

As used herein, the term “enterprise” means any organization created for business ventures. As used herein, the term “data transport bundle” (“DTB”, “DTBs” plural) means a module of data transport services purchased by an enterprise from a network service provider. In the examples, the components that make up such a DTB include the number of transactions, the amount (in MB) of data used, over a period of time and the cost per MB. A DTB can also include other components, such as: overage charges, eligible company type, effective date, end date, speed throttling, quality of service, private networking (VPN), international roaming, off peak and roll over. As used herein, the term “data transport of the DTB” means the component in the DTB that is the amount of data per period of time. The data transport of multiple DTBs may be combined to form a combined data transport component or partitioned and split to form new smaller DTBs and then recombined. As used herein, the term “alternative data plan” (“ADP”) means any data transport package that is an alternative to a billing agreement between a network provider and an existing or new network subscriber for use of data. As used herein, the term “entity” means one or more enterprises that offer the ADP to end users. As used herein, the term “speed throttling” means dynamically implementing network measures that will cap or limit users maximum bandwidth speeds on connections based on predetermined policies and thresholds. As used herein, the term “Quality of Service (QoS)” is a measure of performance that includes the speed of the data flow. QoS may accord various levels of guaranteed performance and different priorities dependent on, for example, application being used, user, data flows, or the type of network technology (lx, 3G, 4G, Wi-Fi). As used herein, the term “Private Network (VPN)” is a type of computer networking--typically using the public internet--that allows users to privately share information between remote locations, or between a remote location and a business' home network. A VPN can provide secure information transport by authenticating users, and encrypting data to prevent unauthorized persons from reading the information transmitted. As used herein, the term “International Roaming” means the extension of network connectivity service in an International location that is different from the home location where the service was registered and which the user's network is not the owner of the network. As used herein, the term “Off Peak” means the period when data usage is expected to be transmitted for a sustained period at a significantly lower than average supply level. As used herein, the term “Roll Over” means the ability to move or “roll over” data not utilized in a period paid for to another period.

The various examples disclosed herein relate to systems and processes enabling multiple enterprises to each purchase a DTB from a network provider or providers, the enterprises to identify another enterprise(s), exchange proposals with the identified enterprise(s) for combining and partitioning the data transport of the DTBs, create an ADP based on the data transport of the combined DTBs, and to offer the ADP for sale to subscribers of the mobile network provider. In addition, the technology facilitates enterprises to purchase a DTB for use by the enterprise itself. Alternatively, the technology facilitates the creation of an ADP by a single enterprise for sale to users/subscribers of the mobile transport network. As used herein, the term DTB means a data plan purchased by an enterprise from a mobile network provider, the data transport of which can be combined with the data transport of other DTBs, either owned by the same enterprise or other enterprises. Based on the agreement between the enterprise and the mobile network provider, the DTB may be limited by the number of transactions, duration, megabyte usage, and/or cost per MB.

Reference now is made in detail to the examples illustrated in the accompanying drawings and discussed below.

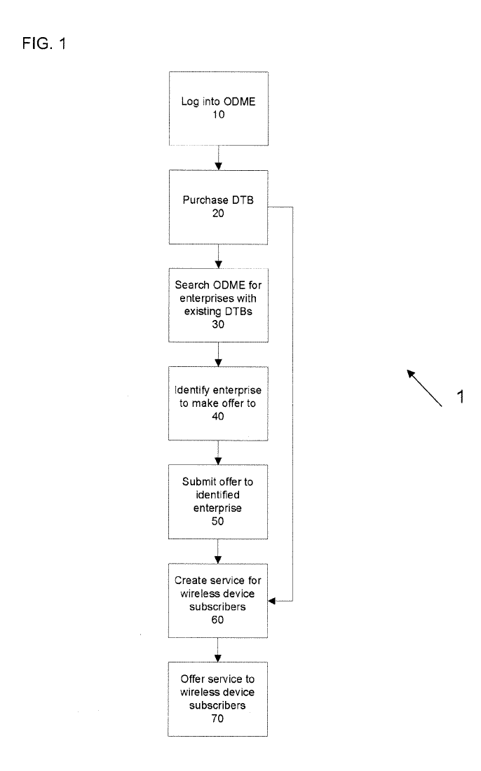

FIG. 1 illustrates an exemplary process for enabling an enterprise to identify another enterprise or multiple other enterprises with which to exchange proposals to create a service, such as an ADP, utilizing the transport service of multiple DTBs, for subscribers of a mobile network. In addition, FIG. 1 illustrates an exemplary process for enabling an enterprise to create an ADP from one or more purchased DTBs.

Referring to FIG. 1, the process begins with a representative of the enterprise logging in to access the Open Data Marketplace Exchange (ODME) web portal (Step 10). The representative accesses the ODME web portal via an Internet connection on a terminal. Examples of such a terminal include a computer having access to the Internet or a mobile device having access to a wireless network that connects to the Internet. In order to maintain the security of the ODME transactions, a representative of each enterprise registers and is verified via a secure token. A user name and password may serve as the secure token that the ODME uses to verify the enterprise itself and that the representative of the enterprise is permitted to access the ODME web portal and make purchases of data transport bundles. Other forms of verification can also be used, such as a credit check of the user. Once the enterprise and representative are verified the representative can create users in the platform and designate them to purchase data, to share data, partition data and submit, accept or reject proposals.

The representative initially registers the enterprise with ODME by submitting information regarding the enterprise and the one or more representatives to the ODME. This information may include the name of the company, address, phone number, and financial information, or bank account number associated with the enterprise or representative, other financial information used for credit verification, as well as the role of the representative in the enterprise (e.g., Chief Technology Officer, Vice President of Marketing). In addition, information on the enterprise may include the types of services the enterprise provides, budget for wireless data purchases and any other information requested by the mobile network provider. The ODME processes the financial information or bank account number with the financial institution or bank in order to verify the identity of the enterprise and/or representative.

During initial registration, the information submitted by the representative is stored by the ODME in the ODME database, which associates the information with the enterprise and representative. The ODME then provides any terms of use of the ODME, which the representative must agree to on behalf of the enterprise in order to use the ODME. The representative is then asked to submit a unique login name and password to use to login into the ODME in the future. The ODME completes the registration process for the enterprise by storing the login information in the ODME database, associating the login information with the enterprise and representative and creating an ODME account number for the registered enterprise. Future transactions related to DTB purchases by the registered enterprise are stored on the ODME database and associated with the enterprise and the ODME account number.

The ODME account for the newly registered enterprise is associated with a messaging account, which the enterprise uses to send, receive, and view messages from the ODME and other enterprises participating in the ODME.

A representative of the enterprise subsequently logs onto the ODME website (step 10) by entering the secure token login information, such as the user name and password provided as above, into an input portion of the ODME website. The inputted identifying information is submitted to the ODME website host server and relayed to the ODME database server to verify the identity of the enterprise and access the enterprise ODME account. The enterprise may then access any messages sent via the ODME website by other enterprises. Such messages may include proposals from other enterprises to combine DTBs.

In a process 1 illustrated in FIG. 1, an enterprise purchases a DTB from the mobile network provider (step 20). In one example, the mobile network provider sets a predetermined minimum and maximum data size (MB) range and number of DTBs that an enterprise is allowed to purchase via the ODME website. The mobile network provider may set these limits based on the enterprise's financial profile. The enterprise is able to view available DTBs that are within the predetermined range via the ODME web portal and that the owner of the DTB makes viewable to other enterprises using the ODME. Those DTBs not within the predetermined range may not be viewable by the enterprise.

This range is determined by the network provider, in part, by the credit score assigned by the network to the enterprise and associated with the enterprise account number and stored in the ODME database. The system may offer the network the ability to assign different enterprises with varying credit levels based on predetermined factors. These predetermined factors may include, for example: the earnings of the enterprise, DTB purchase history, current DTB ownership, and other financial information of the enterprise. This information is provided to the ODME by a representative of the enterprise during initial registration, discussed above, or submitted to the ODME upon request by the ODME, prior to purchase of a DTB. The information is stored in the ODME database and associated with the enterprise account number.

In addition to allowing an enterprise to view and purchase a DTB that is available for viewing and purchase by other enterprise, the network provider may also create a DTB for a specific enterprise. In this case, only that enterprise can view and agree to purchase the DTB using the ODME web portal.

The ODME in the above example enable the enterprise and the mobile network provider to exchange communications, e.g., offer and acceptance of an offer, to complete a commercial transaction relating to the purchase of a DTB. For example, a representative of the enterprise may log onto the ODME as described above, and view all available DTBs offered by the mobile network to the enterprise. The representative of the enterprise may then select one of the DTBs offered for purchase using the ODME web portal and purchase the DTB.

Alternatively, a periodic payment schedule may be set up via the ODME website in which an enterprise is charged for the DTB on a periodic basis. The mobile network provider may also include an overage charge if the amount of data in MBs (Z) in the DTB is exceeded. This overage charge may be assessed at a standard rate or be dependent on the original DTB purchase. In other embodiments, rather than acting as a purveyor of DTBs, the ODME website may support other purchase procedures, e.g., where the mobile network service provider advertises or makes the initial offer in response to a more general query from the enterprise. The composition of the DTB (amount of data, duration, number of transactions, cost) and other details about the DTB may be stored in the ODME server and associated with the enterprise account.

Once the DTB has been purchased, the enterprise can partition the data transport component of the DTB for different uses. For example, if the purchased DTB comprises 5 MB of data for 30 days for a total of 150 MB, the enterprise can partition half, or 75 MB, for consumption by employees of the enterprise and 75 MB to be associated with an ADP for resale to network subscribers (step 60). The enterprise provides the details of how the data transport is to be partitioned to the network provider via the ODME website. These details are stored in the ODME server and consumption of the data transport from the DTB is monitored and stored in the ODME server. This is done when an enterprise creates an ADP. The creation of the ADP indicates that the enterprise is taking the purchased DTB and associating it to a device, URL, web site, etc., for a cost or for free.

For example, in order for employees of the enterprise to consume that portion of data transport of the purchased DTB that has been partitioned and designated for employee use, the enterprise associates employee devices that are to consume the portion of the data transport bundle with identifying information, such as IP addresses of the employee devices. The association may take place at the ODME server. The device identifying information is then provided to the ODME by the enterprise and stored in the ODME server. These designated users/devices are now associated with the partitioned employee portion of purchased DTB and stored in the ODME server. Individual device and user and total use of the data transport from the DTB by these designated users is stored in the ODME server and use information is accessed for viewing by one or more verified representatives of the enterprise.

In addition, according to this example, network subscribers who have purchased an ADP from the enterprise may consume the portion of data transport of the purchased DTB that has been partitioned and designated for the ADP use. Each ADP is associated with a single DTB. In order to use the DTB of the purchased ADP, the enterprise activates and provisions a device to that ADP via a network service provided based on provisioning API. The provisioning can be done for the user by the enterprise or the device can be provisioned by the user through the enterprise via a mobile device, mobile web, or desktop web site. The ADP is associated with a device's MDN (or other unique identifier) at the ODME server.

These ADP users are now associated with the partitioned ADP user portion of the purchased DTB and stored in the ODME server. The individual and total use of the data transport from the DTB by these ADP users is stored in the ODME server and use information is accessed for viewing by one or more verified representatives of the enterprise.

Once the enterprise has purchased the DTB from the mobile network provider, the information regarding the purchased DTB, any ADP associated with the DTB and the enterprise are stored on the ODME database server. The size, duration and transaction components of the purchased DTB as well as details about any ADP associated with the DTB may be available for viewing on the ODME website by other ODME enterprises and the network, although the cost of the DTB may not be available to other ODME users for viewing. The enterprise can explicitly agree to make its purchase viewable to authorized enterprises and restrict which enterprises can and cannot view the purchased DTB and any associated ADP based on criteria such as the primary type of business of the viewing enterprise (for example, the type of business that generates the most revenue for the enterprise, or what the enterprise is known to do, or the business segment of enterprise, for example, healthcare, entertainment, finance, media), target demographic of the enterprise or device type or application type. These restrictions are made using the ODME website. For example the enterprise that owns the DTB may not want competitors engaged in the same business from viewing the purchase of the DTB and any associated ADP and/or only want enterprises located in the same city from viewing the purchased DTB and any associated ADP or, if the enterprise forms a partnership with another enterprise, may grant authorization to see the traffic for the DTB only to the partner enterprise. These preferences may be submitted by a representative of the enterprise on a preferences section of the ODME web portal. These preferences of the enterprise are stored in the ODME database server and associated with the enterprise account. The ODME displays information on the enterprise in accordance with these settings.

the cost of the DTB is not available to other ODME users for viewing.

Following the purchase of the DTB (step 20), a representative of the enterprise in this example can use the ODME website to search the ODME database on the ODME database server for other enterprises participating in the ODME with existing DTBs (step 30).

The search engine is hosted on the ODME database server and the search query is entered on a section of the ODME website. The search engine searches the ODME database for the search terms entered into the search engine and retrieves the results of the search in a list that is displayed on the ODME website to the representative.

For example, the enterprise searches the ODME database for other enterprises (step 30) by including search terms about the various parameters of a DTB in which the enterprise is interested in combining with its purchased DTB. The search by the enterprise is submitted by a representative of the enterprise via an input device such as a keyboard on a terminal, such as a computer connected to the Internet that accesses the ODME website on the ODME website host server. The search terms are sent by the ODME website host server to the ODME database server on which all information submitted by representatives of other enterprises about these about these other enterprises is stored. The database search identifies all enterprises matching the search terms inputted by the enterprise in the ODME search.

Result data indicating all enterprises and DTB requests matching the inputted search terms is sent to the enterprise, for example, in a list of search results. These search results may be displayed to the enterprise via a page of the ODME website or sent via electronic mail or another means to the enterprise. The enterprise may narrow or broaden the ODME search by adding or removing search terms and sort the results by various search terms such as time or size. In reviewing the search results, the representative of the enterprise identifies enterprises to whom to submit an offer to combine DTBs (step 40).

The ODME also allows the enterprise to submit an offer/proposal to the identified enterprise(s) (step 50). This is accomplished by sending a secure message to the identified enterprise(s) via the ODME website that is viewable by the identified enterprise(s) when the identified enterprise(s) logs onto the ODME. Multiple offers of one or more types may be submitted at the same time. The enterprise may include time limits within which the offers may be accepted.

In one example, a proposal may be for combining all or a part of the enterprise DTB with all or part of another DTB owned by the identified enterprise, and/or exchanging ideas on how to use the combined DTBs. The proposal is submitted via the ODME website to the identified enterprise(s) who may receive the proposal via an electronic message sent by the enterprise to the identified enterprise(s) via the ODME website (step 50). The enterprises may then communicate and exchange proposal-related ideas via the ODME.

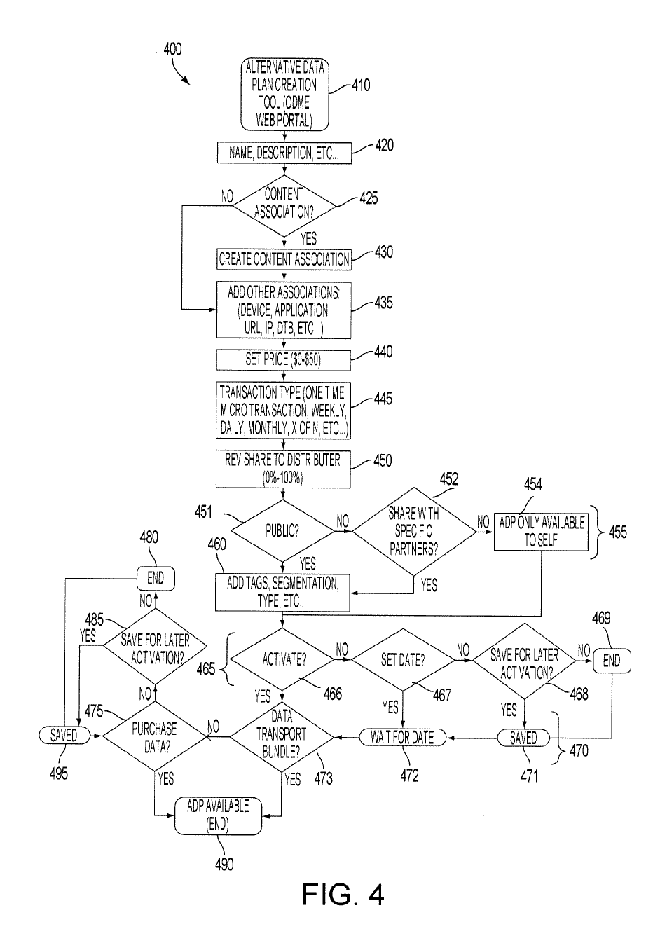

The ODME enables multiple enterprises to exchange communications, e.g., offer and acceptance of offers, to complete a commercial transaction relating to the combining and/or usage of a DTB. Once the enterprises have agreed on the manner in which to use the combined DTBs (owned by each of the enterprises), the enterprises can create an ADP subscriber service (step 60) for network subscribers who consume the DTB(s). As defined above, an ADP means any data transport package that is an alternative to a billing agreement between a network provider and an existing or new network subscriber for use of data. Alternatively, an enterprise which has purchased a DTB may create an ADP directly with searching for and combining DTBS with other enterprises. An ADP is shown in FIG. 4, which is described in detail below.

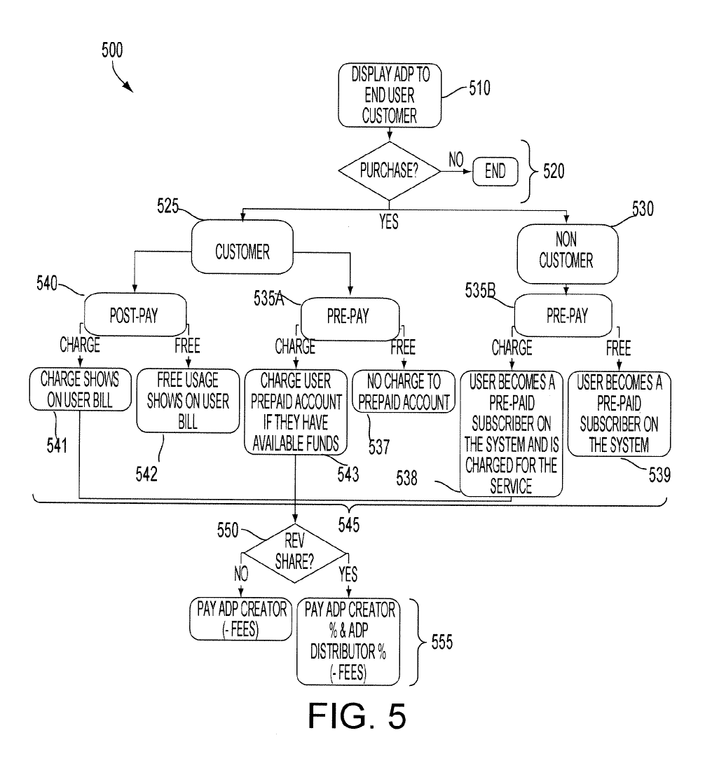

An agreement on how any revenues generated by the ADP service for the network subscribers are to be distributed may be determined prior to creation of the ADP subscriber service via an exchange of communications between the enterprises that may occur via the exchange of messages via the ODME. One or more of the enterprises may serve as the entity that offers the newly created ADP to end users. The ADP may be offered to network subscribers (step 70) by an entity formed by, associated with, and/or representing one or more of the enterprises. This offer of an ADP to network subscribers is shown in FIG. 5, which is described in detail below.

For example, an e-book reader enterprise and a newspaper publisher each purchase a DTB of 1 GB and then agree to combine their 1 GBs together into a 2 GB DTB. The e-book reader enterprise then makes an ADP with the 2 GB and associates it with their device and the newspaper web site. This allows users of the e-reader device to view the newspaper web site without it decrementing from their normal network provider based data plan. In this example, the user may not be a subscriber of the network.

The entity formed by, associated with, and/or representing one or more of the enterprises controls distribution of the ADP subscriber service and selects how the subscriber is billed for use of the ADP subscriber service. When the network provider bills the subscriber, the ODME collects payments by the subscriber for the ADP (less any transaction fees associated with putting this on the subscriber's bill) and passes on the payments to the enterprise that owns the ADP. The enterprise that owns the DTB may then share any profits generated from the ADP as collected by the network provider with other enterprises according to the terms of the agreed upon ADP offer. Alternatively, enterprise may charge the subscriber directly.

As previously discussed, once the ADP subscriber service is established and purchased, it may be activated by a subscriber after the entity provides the subscriber with an access code or other identifier unique to that subscriber. The entity may provide a list of identifiers associated with different ADPs associated with the subscriber service to the network provider via a terminal, via the Internet and the ODME website and this information may be stored on the ODME database server and associated with the DTB.

The subscriber may activate the service using a user device having a wireless connection that is able to connect to the mobile traffic network. In turn, the mobile traffic network may access information on the ODME database server or another network element, such as a mobile wallet that stores information from the ODME via the private network. The private network may receive information stored on the ODME database server to verify the unique identifier and associate the ADP created by the entity to the subscriber account and/or the enterprise account number via the mobile network subscriber server.

The consumption of data according to the rules of the subscriber service is monitored and data consumption records are stored by the network provider in the ODME database server or other server. Each use of the DTB under the rules of the ADP subscriber service may be provided to the entity via the ODME website. Any use of data by subscribers using the subscriber service that is in addition to the amount of data in the DTB may be charged to the entity or to the subscriber. Warnings may be provided to the entity at predetermined intervals when the total amount of data transport being used by subscribers using the ADP subscriber service is close to the maximum amount of data allowable in the DTB.

The ODME may send such warnings to the enterprises that have purchased the DTBs via the ODME as e-mails and/or internal messages. For example, if an enterprise purchases a DTB of 100 GB a month for a 3 month period, this means the enterprise can consume 100 GB in each month before overages are reached or the end customers can no longer access the service. If the enterprise has 100,000 users accessing a photo upload service each day, in month number two on the 20^{th} day the enterprise may receive a notification from the network via the ODME that the entity has consumed 75 GB of their 100 GB monthly allotment. The enterprise can then choose to buy an extra DTB, reset the warning for closer to the allotment or allow it to go into overage if the enterprise so desires. The enterprise may charge subscribers using the ADP that have exceeded the amount of data permitted. Alternatively, the entity may submit a request to the network provider via the ODME web site to restrict the data use of the subscribers, or implement an alternative manner in which to charge a subscriber overage fees.

In addition, multiple network providers and network technologies may offer services via the ODME. Participants of the ODME can view DTBs offered by multiple network providers and can combine DTBs purchased from different network providers to create an ADP service.

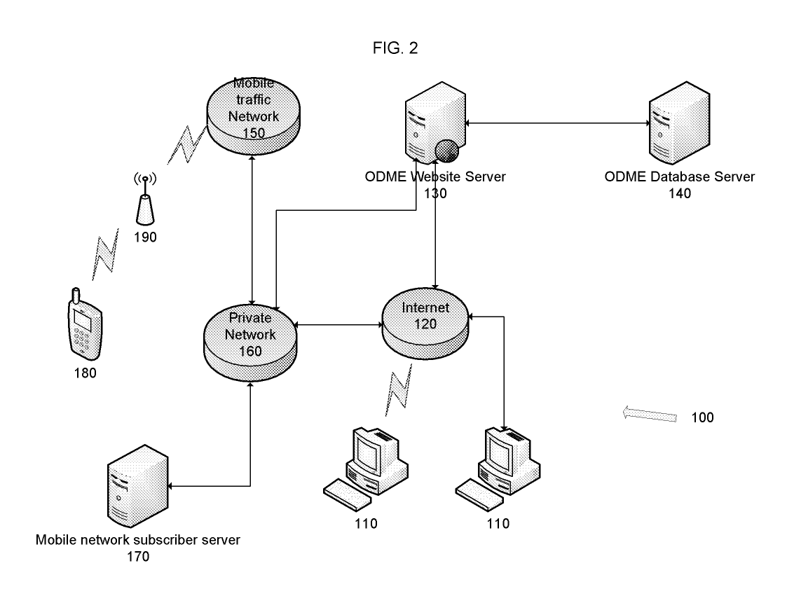

FIG. 2 illustrates an exemplary mobile communication network 100 operated by the network provider. Subscribers of the mobile network 100 may access the Internet 120 using the mobile devices 180 via base stations 190. The base stations 190 communicate with the mobile traffic network 150, which in turn communicates with the private network 160.

Although not separately shown, such a base station 190 typically comprises a base transceiver system (“BTS”). The BTS communicates via an antennae system at the site of base station 190 and over the air and link with one or more of the mobile devices 180 that are within range. Each base station typically includes a BTS coupled to several antennae mounted on a radio tower within a coverage area often referred to as a “cell.”

The BTS is the part of the radio network that sends and receives RF signals to/from the mobile devices that the base station currently serves. The mobile traffic network server 150 connects to a public packet switched data communication network, such as the network commonly referred to as the “Internet” shown at 120. Packet switched communications via the mobile traffic network 150 and the Internet 120 may support a variety of user services, such as mobile device communications of text and multimedia messages, e-mail, web surfing or browsing, programming and media downloading, etc.

The enterprises in these examples search the ODME database on the ODME database server 140 via the website 130 for other enterprises participating in the ODME as discussed above in references to steps 30, 40 and 50. The search by the enterprise(s) is submitted via an input device such as a keyboard on a terminal, such as a computer 110 connected to the Internet 120 that access the ODME website on the ODME website host server 130. The search terms are sent by the ODME website host server 130 to the ODME database server 140 on which all information about all enterprises in the ODME resides to search the ODME database.

The database search identifies all enterprises and for any DTB or ADP requests matching the search terms inputted by the first enterprise in the ODME search. Result data indicating all enterprises and DTB requests matching the inputted search terms is sent to the respective enterprise(s), for example, in a list of search results. These search results may be displayed to the first enterprise via a page of the ODME website or sent via electronic mail or another means to the enterprise(s). The enterprise(s) may narrow or broaden the ODME search by adding or removing search terms.

Once the identified enterprise accepts the offer, the network provider is notified of any combing of DTBs as agreed upon by the enterprises. The combined DTB is partitioned by the network provider according to the terms of the agreed upon offer.

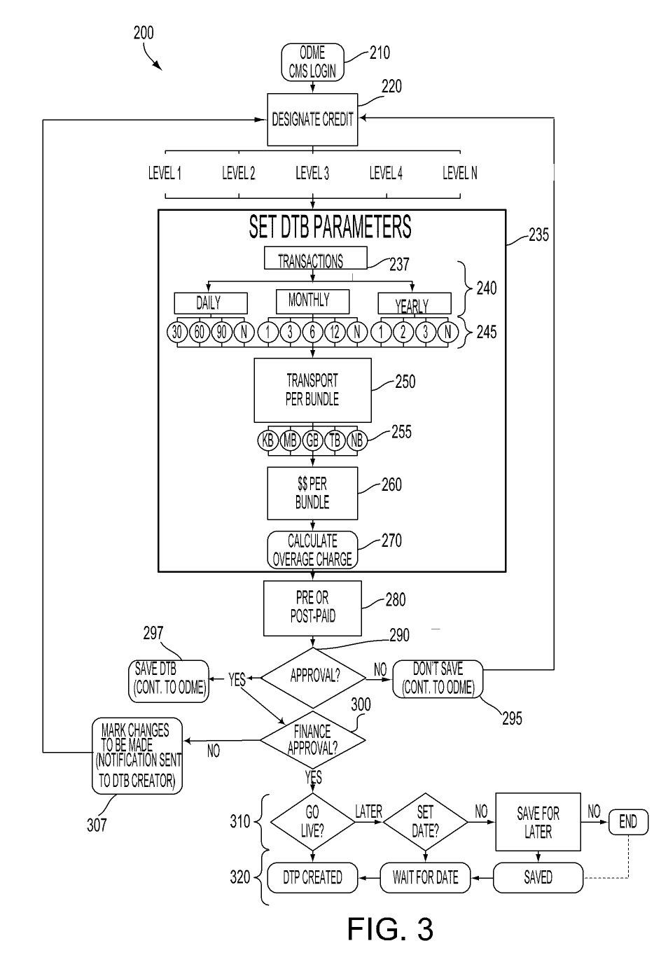

As shown in FIG. 3, in which a process 200 of a network service provider creating a DTB is illustrated, once a representative of an enterprise registers for the ODME and logs in at Step 210, the network designates a credit level to the enterprise at Step 220. Each credit level allows the enterprise access to view and purchase, via the ODME web portal, only those DTBs pre-determined by the network service provider to correspond to a particular credit level. For example, the network designates that a credit level of 1 allows access to DTBs of 1 TB or less, a credit level of 2 allows access to DTBs of 3 TB or less, a credit level of 3 allows access to DTBs of 5 TB or less, and a credit level of 4 allows access to DTBs of 9 TB or less. The network service provider can also determine which DTBs are available at certain credit levels based on other DTB components, in addition to or instead of the amount of data 255. The DTB components or parameters are set in 235, and include the number of transactions at Step 237, duration at Step 240, duration components at Step 245 (number of days, number of months, number of years), amount of data at Step 250, data units 255 (KB, MB, GB, TB, NB), cost per bundle at Step 260, and overage charges at Step 270. Once all of the DTB parameters have been set in 235, the DTB is created.

Payment for the purchase of the DTB may be made at the time it is purchased or paid for later at Step 280. In step 290, the created DTB is submitted to the network for approval. If the network approves the DTB, then the DTB is saved on the ODME server. If the network does not approve the DTB, the DTB is not saved and the process may restart from the step of the network designating the enterprise a credit level, 220. Following network approval any finance approval is requested at step 300. If financing is not approved, then the enterprise is notified that the purchase of the DTB has not been completed and can make changes to the DTB 307 and the process restarts at step 220. If financing is approved, the start date o for use of the DTB at Step 310 is then set. The DTB is then created at Step 320 at the appropriate start date. Steps 310 and 320 are similar to the steps after Step 460, below, and will be explained in more detail with regard to FIG. 4.

FIG. 4 shows an exemplary process 400 for creating an ADP. The exemplary process 400 begins with an entity accessing the ODME web portal and entering an ADP creation tool to create an ADP (Step 410). To create an ADP, the entity assigns a name and a description for the ADP (Step 420). The name and descriptions may be used to identify the ADP as well to inform the users of the nature and functionality of the ADP. For example, for uploading pictures, the description associated with an ADP may be the term “picture uploads.”

The entity may also wish to associate content with the ADP (Step 425). If so, the entity associates a particular content type with the created ADP (Step 430). For example, the ADP may be for accessing the web edition of a newspaper from an electronic tablet device. In this example, the website of the newspaper is associated with the ADP. When the user of the ADP attempts to access the newspaper from the user's electronic tablet, the network recognizes the website as being associated with the ADP and processes the request to access the website according to the rules of the ADP. For instance, the ADP may allow for free access to the newspaper website. If the entity does not wish to associate content type with the ADP, the process moves forward to Step 435. In Step 435, the entity associates other parameters with the ADP. The other parameters may include one or more devices, applications, URL, IP, and/or DTB. For example, the other parameters may include the newspaper website as described above, and a digital camera associated with the ADP which allows uploading of pictures.

The entity also sets the price associated with the ADP (Step 440). For example, the price may be from $0 to $50. The price of the ADP is further associated with a transaction type (Step 445). For example, the particular price may be for one time, daily, weekly, monthly, etc. uses. Based on the price and the transaction type, the customer utilizing the ADP pays the entity creating the ADP the set price. The entity may use part of the revenue from the usage of the ADP with the mobile communication network provider to pay for the created DTB (Step 450). When the transaction is set for one time, then the user may only use the ADP for a single transaction. Weekly, daily and monthly transactions allow for transactions of data on a once a week, once a day and once a month basis respectively. The ADP may also set the price for a micro transaction, i.e., a transaction subsequent to a first top-level transaction. For example, the entity may offer the download and viewing of an internet newspaper for free, however, the entity may charge for the viewing of the opinion section of the internet newspaper. In this example, the viewing of the opinion section of the internet newspaper is a micro transaction.

The availability of the ADP is then set in Step 455, which encompasses several individual steps. The availability of the ADP may be public (Step 451, Yes), or shared with specific partners of the entity (Step 452, Yes) or kept only to the enterprise itself (Step 454). An enterprise may make the ADP only available to itself in situations when it is not ready to activate the ADP or only wants to make the ADP available to employees of the enterprise. Once the availability of the ADP is set, tags are added to the ADP at Step 460.

Once the availability of the ADP is set and tags are added, the ADP may be activated at different points in time (Step 465). For example, the ADP can be activated right away (Step 466), in which case, the ADP is linked to one or more DTBs at Step 473 and if desired the enterprise may purchase more data at Step 475. If there is sufficient data for the ADP, the ADP is activated at Step 490. If it is determined at Step 485 that there is insufficient data for the ADP and additional data is not purchased, then the ADP may be saved for later activation (Step 495) or the ADP may be terminated (Step 480).

Alternatively, the ADP may be set for activation for an enterprise-set date in the future (Step 467), for example, in order to coincide with the sale of a particular product that will use the ADP. In this scenario, when the activation date arrives (Step 472), one or more DTBs are linked with the ADP (Step 473). If there is sufficient data available for the ADP, then the ADP is activated (Step 490). If additional data is needed, then additional data can be purchased at Step 475, as indicated above.

The ADP can also be saved for later activation (Step 468), for example, when a product that is anticipated to use the ADP is ready to be sold. In scenarios when the enterprise decides it does not wish to active the ADP, the activation step is ended (Step 469) and the ADP is saved (Step 471). The ADP may be saved on a server (Step 471), an activation start date for activation of the ADP is then awaited (Step 472), a DTB is associated with the ADP (Step 473) and if desired, a new DTB is purchased (Step 475).

As shown in FIG. 5, in which a process 500 for purchasing an ADP is illustrated, the ADP is displayed to a customer (Step 510) for purchase (Step 520). This display of the ADP (Step 510) may be done by including an offer of the ADP with a purchased product, such as a digital camera or electronic tablet. Alternatively the ADP offer may be sent to subscribers of a network via electronic mail. If the customer is a network subscriber (Step 525), the customer may pay for the ADP after use of the ADP has commenced, i.e., post-pay (Step 540). In this scenario, ADP charges are shown on the customer's bill (Step 541). In another scenario, the customer (who is a network subscriber) is given usage of the ADP for free, (Step 542) and this free or complimentary ADP service is shown on the network subscriber's bill. Alternatively, the customer (who again is a network subscriber) can pay for the ADP before ADP usage has commenced, i.e., pre-pay (Step 535A). In this scenario, the customer's account is charged for the ADP prior to ADP usage, if the customer's account has available funds (Step 543). Alternatively, the customer's pre-paid account may not be charged for the ADP (Step 537). The various ways in which a user is charged for use of the ADP are shown collectively as Step 545.

If the user is not already a network subscriber (Step 530), in the example shown in FIG. 5 the customer must pre-pay (Step 535B). In this scenario, the user pays the network provider in advance of the commencement of any ADP service (pre-pay) and thereby becomes a pre-paid subscriber on the system and is charged for the ADP service, the charges being deducted from the pre-paid amount (Step 538). Alternatively, a user who is not a network subscriber may set up a pre-pay account (Step 535) but receive the service for free. In this scenario, the user becomes a pre-paid subscriber on the system (Step 539).

Any prior revenue sharing between enterprise offering the ADP and/or the network is determined (Step 550) and revenue distribution is executed (Step 555). If revenue sharing is part of the ADP, then the ADP creator is paid a percentage of the revenue, as well as the distributor, less any fees. If the network collects revenues by billing the use, then the network acts as the distributor, distributing the revenue less any fees.

The following is a summary of exemplary scenarios creating an ADP: 1) A single enterprise purchases a DTB and creates an ADP for network subscribers; 2) A single enterprise purchases multiple DTBs from the same or different network providers and combines part or all of some or all of the data transport of the DTBs to create an ADP; 3) Multiple enterprises purchase DTBs from the same or different network providers and partition and combine the data transport of the respective DTBs to create an ADP.

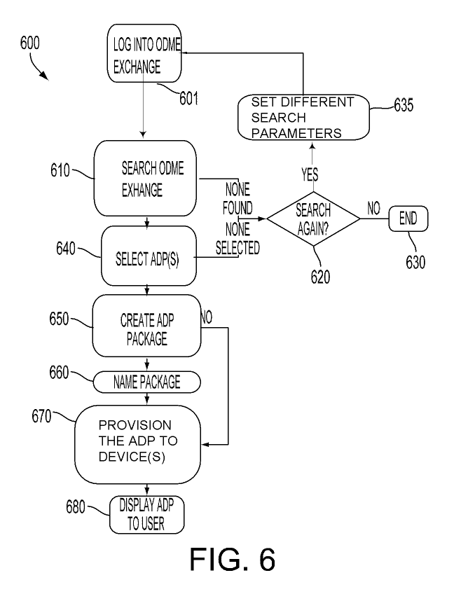

As shown in FIG. 6, in which a process 600 is shown for an enterprise to use the ODME web site to search the ODME exchange using an ODME search tool for participating enterprises with an existing ADP. The enterprise first logs into the ODME exchange (Step 601) and then searches the ODME exchange (Step 610) using a search engine of the ODME web site to enter search criteria that the enterprise is interested in finding in an existing ADP. For example, the enterprise enters the term “picture uploads” for an existing ADP that is for use by customers to upload pictures to a website. If the search engine returns no results for the entered search term(s), then the enterprise is asked if it would like to search again (Step 620). If the enterprise decides to search again, then the ODME may be searched by setting different search parameters 635. If the enterprise does not decide to search again, then the search ends, (Step 630). If an ADP or ADPs are found that match the entered search criteria, then the enterprise may select the matching ADP (Step 640), create an ADP package (Step 650), and optionally name the package, (Step 660). The API is used to provision the ADP to the device via the network platform (Step 670). The provisioning of the device may be done synchronously (i.e. at the same time the ADP package is created) or asynchronously (i.e. at a time later than when the ADP package is created). The ADP is then available to the user for display (Step 680) as described above.

### Examples/Applications

An enterprise, which owns a theme park, utilizes the ODME to develop a service to promote visitors to its theme park. The enterprise decides that allowing visitors to share pictures of their visit to the theme park on photo sharing websites may encourage viewers of the pictures to visit the theme park. The enterprise joins the ODME and submits information to the network provider regarding the size, revenue and other financial information about the first enterprise. The network provider reviews the submitted information and if the information meets the predetermined requirements for joining the ODME, provides the first enterprise access to the ODME by granting login information and storing the submitted information in the ODME database server.

The enterprise logs into the ODME to purchase a DTB. The enterprise searches the ODME database for companies that provide photo-related services. The enterprise submits, via the ODME, one or more offers for combining the purchased DTB with other enterprises that own a DTB listed in the results of the search, as determined by the enterprise. The enterprise also submits offers to all enterprises who reply to an initial proposal by the enterprise to combine DTBs. The offers may include a time limit for responding. Any of the other enterprises receiving an original proposal from the enterprise can submit counter proposals or questions requesting more information on the offer to the enterprise via the ODME. The enterprise then decides to choose one or more of the enterprises who have accepted its proposal. The original proposal is made to an enterprise that sells cameras and is able to offer to sell a camera that will connect to the mobile network of the network provider at a predetermined price. The price of the camera can be offered at a discount from the regular price and access to a photo sharing website (in addition or alternatively to the discounted camera price) may be offered. The two enterprises share the cost of combining the DTBs and portioning the combined DTB and revenue generated by the sale of the camera bundled with data transport service to the users. The two enterprises then launch a promotional campaign for an ADP in which each family coming to the theme park is able to purchase a wireless camera having an embedded modem for connecting to the network. Photos taken using the camera are automatically uploaded to the photo sharing website of the enterprise that sells cameras and shared with friends and family in real time, as indicated in the promotional campaign. The camera is able to connect to the Internet via the mobile network and send picture files to the picture sharing website.

As another example, an enterprise which makes athletic shoes utilizes the ODME to search for other enterprises with which to share the cost of creating an ADP, combining DTBs and any revenue generated by sales of the shoe or sale of the wireless service the shoe can provide to customers. The enterprise logs into the ODME as per the above example and searches for other enterprises with products or services which may compliment its own products. The enterprise enters keyword identifiers including those identifying athletic clubs, Internet radio websites, and health foods/stores into the ODME search. The enterprise submits proposals for combining a DTB to the enterprises listed in the ODME search results and decide to partner with an Internet radio web site to combine DTBs so that customers buying athletic shoes from the enterprise may gain free access to the Internet radio web site from their wireless device subscribed to the network. The athletic shoes are sold with an ADP promoting free access to the radio Internet site. For example, the shoe company wants to promote a new running shoe that not only tracks how much and far a person runs but the style of running. To make running more enjoyable they want to partner with a company that has a web based Internet radio program. The running style of the runner, fast, slow, rough, uphill, etc... will dictate the style of music played. While the shoe is being sold by the shoe company, the device getting the free data transport is the internet radio music on the user's mobile device. Either the shoe company or the Internet Radio Company can pay the network provider for the transport. Or both can pay separately for the transport and combine it in the ODME into a single AD that the network provider will manage for them.

In another example, an e-book reader device company joins the ODME, purchases a DTB and partitions a portion of the DTB for combination with a partitioned portion of a DTB purchased by a newspaper publisher via the method described above using the ODME. The combined DTB is designated for as and ADP for use by users of the e-book reader device for free downloading of copies of the newspaper via the internet.

In another example, an e-book application is available for purchase for $5. The e-book application provider company joins the ODME, purchases a DTB and partitions a portion of the DTB for combination with a partitioned portion of a DTB purchased by a newspaper publisher and a partitioned portion of a DTB purchased by an electronic tablet manufacturer via the method described above using the ODME. The combined DTB is designated for an ADP for users of the electronic tablet using the e-book application device for downloading of copies of the newspaper via the internet. This service is offered for free with the purchase of the e-book application.

In another example, a manufacturer of a camera with a wireless modem would like to offer an ADP for users of the camera to upload pictures to a photo sharing website for a cost of $5 a month for 25 pictures per month of less than 50 KB in size. The camera manufacture purchases a DTB using the ODME as described above and then creates an ADP by naming it, associating the manufacturers camera models having a wireless modem and providing the details of the ADP ($5 a month for 25 pictures per month of less than 50 MB in size). The created ADP is then shared with those participants in the ODME who offer photo sharing websites. At the same time, the camera manufacturer searches the ODME for participants in the ODME who offer photo sharing web sites and which own a DTB that includes at least 1 TB of data transport. A photo sharing website sees the newly created ADP and contacts the camera manufacturer via the ODME to express interest in combining its 3 TB of data transport with the data transport of the camera manufacturer to share in the revenue created by the ADP. The details of the revenue sharing and how an end user is charged for the ADP is agreed upon by the camera manufacturer and the photo sharing website enterprise and the ADP is activated for new and existing owners of the associated cameras. In this example, users of the ADP pay for the ADP online every month via the photo sharing website. The collected revenue is then shared equally between the camera manufacturer and the photo sharing website. The camera manufacturer places the information about the ADP and how to purchase the ADP in the packaging of new cameras and sends an email offer, offering the ADP for purchase to existing owners of the associated camera models. If the users of the camera wish to purchase the ADP the users purchase the ADP via the photo sharing website.

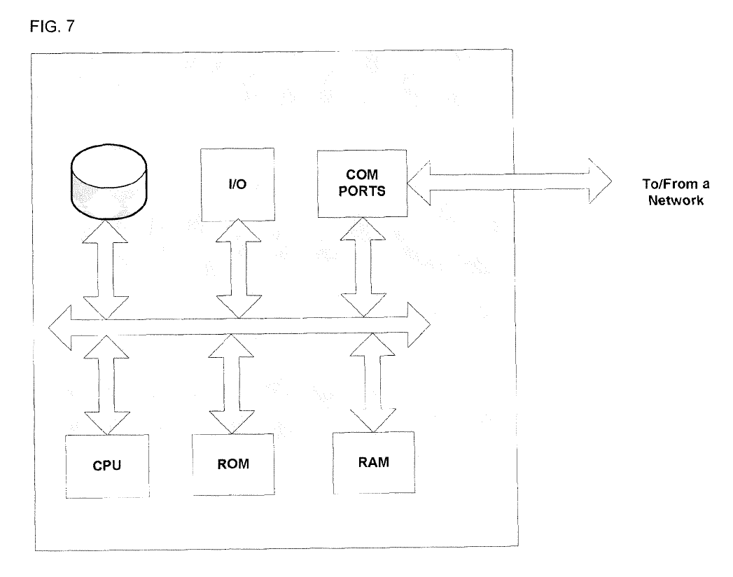

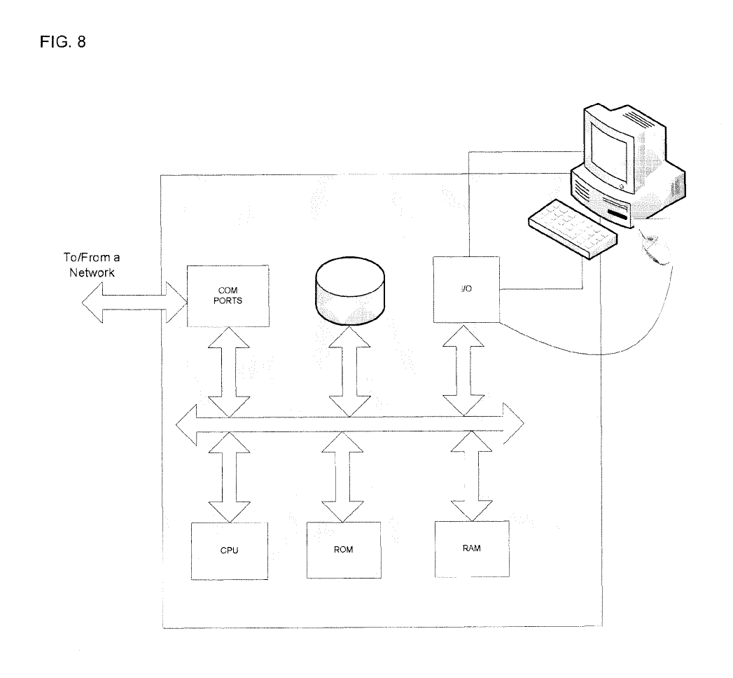

FIGS. 7 and 8 provide functional block diagram illustrations of general purpose computer hardware platforms. FIG. 7 illustrates a network or host computer platform, as may typically be used to implement a server like the ODME web site host server 130 or the ODME database server 140. FIG. 8 depicts a computer with user interface elements, as may be used to implement a personal computer or other type of work station or terminal device, although the computer of FIG. 8 may also act as a server if appropriately programmed. It is believed that those skilled in the art are familiar with the structure, programming and general operation of such computer equipment and as a result the drawings should be self-explanatory.

A platform for a server or the like, for example, includes a data communication interface for packet data communication. The platform also includes a central processing unit (CPU), in the form of one or more processors, for executing program instructions. The platform typically includes an internal communication bus, program storage and data storage for various data files to be processed and/or communicated by the platform, although the server often receives programming and data via network communications. The hardware elements, operating systems and programming languages of such equipment are conventional in nature, and it is presumed that those skilled in the art are adequately familiar therewith. Of course, the various ODME server functions may be implemented in a distributed fashion on a number of similar platforms, to distribute the processing load. Alternatively, the servers 130 and 140 may be implemented by appropriate programming of one computer hardware platform.

Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the server(s) of the ODME type exchange. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A server comprising at least one processor;
a non-transitory storage medium; and
one or more files stored in the non-transitory storage medium for processing by the at least one processor, the one or more files defining a data transport bundle (DTB), wherein the DTB is a package of wireless data transport for sale to an enterprise by a mobile communication network provider for services that use wireless data transport, and the one or more files have a data structure containing parameters of the DTB comprising:
a duration defining a time period during which the data transport bundle is valid;
a number of allowed transactions for the data transport bundle;
a megabyte (MB) size associated with each of the allowed transactions; and
a price associated with the data transport bundle.

2. The server of claim 1, wherein the data structure of the one or more files allow the DTB to be available to the enterprise irrespective of amount of data the enterprise has purchased from the mobile communication network provider in the past or would like to purchase in the future.

3. The server of claim 1, wherein the data structure of the one or more files allow duration, the number of allowed transactions, and the size of the DTB to be adjustable to satisfy services for which the enterprise purchases the data transport.

4. The server of claim 1, wherein the one or more files allow the DTB to be partitioned into a plurality of data transport bundles.

5. The server of claim 1, wherein the one or more files allow the DTB to be combined with another DTB to create a combined DTB.

6. The server of claim 5, wherein the one or more files allow the combined DTB to be associated with an alternative data plan (ADP).

7. The server of claim 1, wherein the one or more files allow the DTB to be shared by the enterprise with another such that profits generated by the DTB are shared by the enterprises.

8. The server of claim 1, wherein the one or more files allow the DTB to be sold by the enterprise to another enterprise.

9. The server of claim 1, wherein the one or more files have a data structure wherein the price associated with the DTB comprises overage charges.

10. The server of claim 1, wherein the one or more files have a data structure wherein the price associated with the DTB to comprises international roaming charges.

11. The server of claim 1, wherein the one or more files have a data structure wherein the price associated with the data transport bundle is a function of the quality of service (QoS) of the wireless data transport.

12. The server of claim 11, wherein the one of more files allows the QoS offered in the DTB to differ depending on the type of network technology allowed to use the DTB.

13. A method, comprising steps of:
exchanging an offer and acceptance to create an agreement between a mobile communication network provider and an enterprise for the mobile communication network provider to provide a data transport bundle as a package of wireless data transport to the enterprise through the mobile communication network for creation of services of the enterprise that use wireless data transport, the data transport bundle comprising:
a duration defining a time period during which the data transport bundle is valid,
a number of allowed transactions defining a number of transactions that are allowed for the data transport bundle,
a megabyte (MB) size associated with each of the allowed transactions, and
a price associated with the data transport bundle,
providing data transport through the mobile communication network for customers of the enterprise, consuming the data transport bundle; and
responsive to operation of the mobile communication network, accumulating and processing data regarding the consumption of the data transport bundle via a computer, to account for the transport consuming resources of the data transport bundle in accordance with the data transport bundle agreement.

14. The method of claim 13, wherein the DTB is available to the enterprise irrespective of the amount of data the enterprise has purchased in the past or would like to purchase in the future.

15. The method of claim 13, further comprising a step of adjusting the duration, the number of allowed transactions, and the size of the DTB to satisfy services for which the enterprise purchases the data transport.

16. The method of claim 13, further comprising a step of partitioning the DTB into a plurality of data transport bundles.

17. The method of claim 13, further comprising a step of combining the DTB with another DTB to create a combined DTB.

18. The method of claim 14, further comprising a step of associating the combined DTB with an alternative data plan (ADP).

19. A system, comprising:
a mobile communication network of a network service provider configured to provide transport for mobile data communication services;
a billing system computer coupled to one or more elements of the mobile communication network, the billing system configured to process data regarding usage of the transport for mobile data communication services through the mobile communication network;
a server comprising at least one processor;
a non-transitory storage medium; and
one or more files stored in the non-transitory storage medium for processing by the at least one processor, the one or more files defining a data transport bundle (DTB), wherein the DTB is a package of wireless data transport for sale to an enterprise by a mobile communication network provider for services that use wireless data transport, and the one or more files have a data structure containing parameters of the DTB comprising:
a duration defining a time period during which the data transport bundle is valid;
a number of allowed transactions for the data transport bundle;
a megabyte (MB) size associated with each of the allowed transactions; and
a price associated with the data transport bundle.

20. One or more files stored in a non-transitory storage medium for processing by the at least one processor, the one or more files defining a data transport bundle (DTB), wherein the DTB is a package of wireless data transport for sale to an enterprise by a mobile communication network provider for services that use wireless data transport, and the one or more files have a data structure containing parameters of the DTB comprising:
a duration defining a time period during which the data transport bundle is valid;
a number of allowed transactions for the data transport bundle;
a megabyte (MB) size associated with each of the allowed transactions; and
a price associated with the data transport bundle.
